(19) United States
(12) Patent Application Publication
(10) Pub. No.: US 2025/0116945 A1
(43) Pub. Date: Apr. 10, 2025

(54) TONER

(71) Applicant: CANON KABUSHIKI KAISHA, Tokyo (JP)

(72) Inventors: KENJI AOKI, Shizuoka (JP); TATSUYA SAEKI, Shizuoka (JP); YUKI MASUDA, Shizuoka (JP); MEGUMI YAMAUCHI, Shizuoka (JP); NAOYA ISONO, Shizuoka (JP)

(21) Appl. No.: 18/903,203

(22) Filed: Oct. 1, 2024

(30) Foreign Application Priority Data
Oct. 10, 2023 (JP) 2023-175142

(51) Int. Cl. G03G 9/08; G03G 9/087

(52) U.S. Cl. CPC G03G 9/0819; G03G 9/08728; G03G 9/08782

(57) ABSTRACT

A toner including a toner particle, wherein a weight-average particle size of the toner is a specific range, a domain-matrix structure in which a domain is dispersed in a matrix is observed on a cross-section of the toner, the matrix includes a crystalline resin A, the domain includes an amorphous resin B, where the domain with a major axis of 300 nm or more is defined as domain C, and the domain with a major axis of 200 nm or less is defined as domain D, a number-average major axis of the domain D is 30 to 150 nm, and a proportion of the cross-section which satisfies (i) and (ii) is 90% or more; (i) 5 to 20 of domains C are present per cross-section and an area ratio of the domain C is 10 to 30%, (ii) the domain D is observed over an entire region in the cross-section.

### BACKGROUND OF THE INVENTION

### Field of the Invention

The present disclosure relates to a toner for use in electrophotography and electrostatic recording.

### Description of the Related Art

Energy saving is considered to be a major technical issue in electrophotography devices as well, and a significant reduction in the amount of heat applied in fixing devices is being researched. In particular, there is a growing need for toners with the so-called “low-temperature fixability” that enables fixing with lower energy.

In addition, in recent years, there has been a demand for resistance against erasure-induced abrasion to prevent printed symbols from being erased by an eraser and falsified.

As a method for enabling fixing at low temperatures, in WO 2013/047296, a toner to which a plasticizer has been added is researched. The plasticizer has the effect of accelerating the softening rate of the binder resin while maintaining the glass transition temperature (Tg) of the toner and can improve low-temperature fixability. However, since the toner softens through a step in which the plasticizer melts and then the binder resin is plasticized, there is a limit to the melting rate of the toner, and further improvement in low-temperature fixability is desired.

Accordingly, a method of using a crystalline resin as a binder resin is being researched. Amorphous resins that are generally used as binder resins for toners do not show a clear endothermic peak in differential scanning calorimetry (DSC) measurements, but where a crystalline resin component is included, an endothermic peak (melting point) appears in DSC measurements.

In crystalline resins, the molecular chains are regularly arranged, thereby preventing softening at temperatures lower than the melting point. Further, when the melting point is exceeded, the crystals melt suddenly, which is accompanied by a rapid drop in viscosity. For this reason, crystalline resins have attracted attention as materials that have excellent sharp melt property and low-temperature fixability.

There is a toner that uses a crystalline vinyl resin with a long-chain alkyl group on the side chain in the molecule as a crystalline resin. Usually, crystalline vinyl resins have a long-chain alkyl group as a side chain in the main chain skeleton, and the long-chain alkyl groups in the side chains crystallize with each other to form a crystalline resin. Japanese Patent Application Publication No. 2014-142632 and Japanese Patent Application Publication No. 2022-144501 propose a toner having a domain-matrix structure having a matrix containing a crystalline vinyl resin and a domain containing an amorphous resin.

### SUMMARY OF THE INVENTION

Meanwhile, the present inventors recognized that toners containing a crystalline resin generally have a problem of low eraser abrasion resistance. Since crystalline resins have a lower polarity than commonly used binder resins for toners, the crystalline resins have a low affinity with paper containing cellulose as a main component. Therefore, in a test conducted to measure abrasion resistance in a state under a certain pressure such as applied when rubbing with an eraser, it is believed that the toner is likely to peel off. The toners described in Japanese Patent Application Publication No. 2014-142632 and Japanese Patent Application Publication No. 2022-144501 have excellent low-temperature fixability, but there is still room for improvement in terms of eraser abrasion resistance during low-temperature fixing.

Furthermore, the domains containing an amorphous resin have a relatively slower melting rate during low-temperature fixing than the matrix containing a crystalline resin. The toners described in Japanese Patent Application Publication No. 2014-142632 and Japanese Patent Application Publication No. 2022-144501 have a large domain size, fine irregularities are generated on the surface of the fixed image during low-temperature fixing, and gloss is likely to decrease. Therefore, further improvements are required to realize a toner that has excellent low-temperature fixability and high gloss over a wide temperature range, and further has excellent eraser abrasion resistance during low-temperature fixing.

The present disclosure is directed to a toner that has excellent low-temperature fixability and high gloss over a wide temperature range, and further has excellent eraser abrasion resistance during low-temperature fixing.

According to at least one aspect of the present disclosure, there is provided a toner comprising a toner particle comprising a crystalline resin A and an amorphous resin B, wherein
a weight-average particle size of the toner is 4.0 to 10.0 μm;
when a cross-section of the toner is observed with a scanning transmission electron microscope,
   a domain-matrix structure in which a domain is dispersed in a matrix is observed in the cross-section,
   the matrix comprises the crystalline resin A,
   the domain comprises the amorphous resin B,
   (a) where the domain with a major axis of 300 nm or more is defined as domain C, and the domain with a major axis of 200 nm or less is defined as domain D, a number-average major axis of the domain D is 30 to 150 nm, and
   (b) a proportion of the cross-section which satisfies both of the following (i) and (ii) is 90% or more by number,
(i) 5 to 20 of domains C are present per cross-section of one toner particle, and an area ratio of the domain C is 10 to 30% by area based on an area of the cross-section,
(ii) the domain D is observed over an entire region of a region except for the domain C in the cross-section.

According to at least one aspect of the present disclosure, there is provided a toner that has excellent low-temperature fixability and high gloss over a wide temperature range, and further has excellent eraser abrasion resistance during low-temperature fixing.

Further features of the present invention will become apparent from the following description of exemplary embodiments.

### DESCRIPTION OF THE EMBODIMENTS

In the present disclosure, the descriptions of “XX or more and YY or less” or “XX to YY” representing numerical ranges mean numerical ranges including the lower and upper limits, which are endpoints, unless otherwise specified. When numerical ranges are stated stepwise, the upper and lower limits of each numerical range can be combined arbitrarily.

In the present disclosure, a (meth)acrylic acid ester means an acrylic acid ester and/or a methacrylic acid ester.

In addition, in the present disclosure, wording such as “at least one selected from the group consisting of XX, YY and ZZ” means any of: XX; YY; ZZ; a combination of XX and YY; a combination of XX and ZZ; a combination of YY and ZZ; or a combination of XX and YY and ZZ.

The term “monomer unit” describes a reacted form of a monomeric material in a polymer. For example, one carbon-carbon bonded section in a principal chain of polymerized vinyl monomers in a polymer is given as one unit. A vinyl monomer can be represented by the following formula (6):

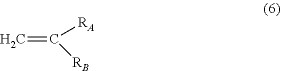

In formula (6), R_{A} represents a hydrogen atom or alkyl group (preferably a C1-3 alkyl group, or more preferably a methyl group), and R_{B} represents any substituent.

A crystalline resin is a resin exhibiting a clear endothermic peak in differential scanning calorimetry (DSC) measurement.

The inventors have found that the above problems can be solved by appropriately controlling the size, number and area of the large and small domains in a toner having a domain-matrix structure with a matrix containing a crystalline resin and domains containing an amorphous resin when the cross-section of the toner is observed.

The present disclosure relates to a toner comprising a toner particle comprising a crystalline resin A and an amorphous resin B, wherein
a weight-average particle size of the toner is 4.0 to 10.0 μm;
when a cross-section of the toner is observed with a scanning transmission electron microscope,
   a domain-matrix structure in which a domain is dispersed in a matrix is observed in the cross-section,
   the matrix comprises the crystalline resin A,
   the domain comprises the amorphous resin B,
   (a) where the domain with a major axis of 300 nm or more is defined as domain C, and the domain with a major axis of 200 nm or less is defined as domain D, a number-average major axis of the domain D is 30 to 150 nm, and
   (b) a proportion of the cross-section which satisfies both of the following (i) and (ii) is 90% or more by number,
(i) 5 to 20 of domains C are present per cross-section of one toner particle, and an area ratio of the domain C is 10 to 30% by area based on an area of the cross-section,
(ii) the domain D is observed over an entire region of a region except for the domain C in the cross-section.

By creating a domain-matrix structure formed of a matrix containing crystalline resin A and domains containing amorphous resin B in cross-sectional observation of the toner, excellent low-temperature fixability can be obtained. If there is no domain-matrix structure and crystalline resin A and amorphous resin B are compatible and form a uniform structure, the sharp melting property of the crystalline resin is likely to decrease, and low-temperature fixability is likely to decrease.

In general, crystalline resins have a high melting rate. Therefore, during low-temperature fixing, a melting rate difference occurs between the crystalline resin and the amorphous resin, which has a relatively slow melting rate. As a result, the fixing ends before the amorphous resin is completely melted, which can cause small irregularities in the fixed image due to insufficiently melted amorphous resin, and gloss can decrease. Therefore, in order to achieve high gloss during low-temperature fixing, the domains containing amorphous resin B need to be relatively small. Therefore, with regard to (a), the number-average major axis of domains D is 150 nm or less.

Meanwhile, during fixing at higher temperatures, the amorphous resin with small domains can be sufficiently melted and can penetrate too much into the gaps in the paper together with the crystalline resin. As a result, the gloss can decrease due to the effect of unevenness of the paper. Therefore, in order to achieve high gloss during fixing at higher temperatures, the domains containing amorphous resin B need to be relatively large. Therefore, with regard to (a), the number-average major axis of domains D is 30 nm or more.

Also, as mentioned above, crystalline resins that have low affinity with paper have the problem of poor eraser abrasion resistance. Therefore, it is important to control the domains that contain amorphous resin. Where the size of the domains made of amorphous resin is small, the amorphous resin can enter the gaps between the fibers of the paper during low-temperature fixing and adhere to the paper. Meanwhile, where the size of the domains made of amorphous resin is large, the amorphous resin can increase the surface area and adhere to the paper fibers. Therefore, the eraser abrasion resistance can be improved if the domains of a relatively small size and the domains of a relatively large size are present in a certain proportion and if the domains are widely dispersed in the toner. Accordingly, (a) and (b) are satisfied.

The toner will be described in detail below.

When a cross-section of the toner is observed under a scanning transmission electron microscope, a domain-matrix structure in which domains are dispersed in a matrix is observed in the cross-section. The matrix includes crystalline resin A, and the domains include amorphous resin B. Where the domain with a major axis of 300 nm or more is referred to as domain C, and the domain with a major axis of 200 nm or less is referred to as domain D, a number-average major axis of domains D is from 30 nm to 150 nm.

As a result of the matrix containing crystalline resin A, excellent low-temperature fixability is obtained. As a result of the number-average major axis of domains D being from 30 nm to 150 nm, a toner with excellent high gloss properties is obtained over a wide temperature range. Where the number-average major axis of domains D is smaller than 30 nm, the domains D can penetrate too much into the gaps in the paper during fixing at a higher temperature, and the gloss can decrease due to the effect of unevenness of the paper. Meanwhile, where the number-average major axis of domains D is larger than 150 nm, the domains D will not melt enough during low-temperature fixing, causing unevenness of the toner on the surface of the paper and thereby reducing gloss. The number-average major axis of domains D is preferably from 40 nm to 120 nm, and more preferably from 50 nm to 100 nm.

The number-average major axis of domains D can be controlled by the proportion of crystalline components in crystalline resin A, the proportion of components in amorphous resin B that have a high affinity with crystalline resin A, and the ratio of crystalline resin A and amorphous resin B. Specifically, the number-average major axis of domains D can be increased by increasing the proportion of crystalline components in crystalline resin A, decreasing the proportion of components in amorphous resin B that have a high affinity with crystalline resin A, and decreasing the ratio of crystalline resin A. Further, the number-average major axis of domains D can be decreased by decreasing the proportion of crystalline components in crystalline resin A, increasing the proportion of components in amorphous resin B that have a high affinity with crystalline resin A, and increasing the ratio of crystalline resin A.

In the present disclosure, (b) the proportion of the cross-sections which satisfy both of the following (i) and (ii) is 90% or more by number,
(i) 5 to 20 of domains C are present per cross-section of one toner particle, and an area ratio of the domain C is 10 to 30% by area based on an area of the cross-section; and
(ii) the domain D is observed over an entire region of a region except for the domain C in the cross-section.

When the proportion of the cross-sections in which domains C and D satisfy both (i) and (ii) is 90% or more, the toner has excellent eraser abrasion resistance during low-temperature fixing. Where the number and area ratio of domains C are small, the number of domains that can adhere to the paper fibers over a large area decreases, and the eraser abrasion resistance decreases. Meanwhile, where the number and area ratio of domains C are large, unevenness of the toner occurs on the surface of the paper during low-temperature fixing, and the gloss decreases.

Furthermore, where domains D are not present over the entire region in the region except for domains C, that is, where domains D are present unevenly, there will be portions where domains D cannot get into the gaps in the paper and cannot adhere, which will result in reduced eraser abrasion resistance. Therefore, where the proportions of cross-sections of the toner that satisfy both (i) and (ii) is less than 90%, the eraser abrasion resistance will be reduced. The proportion of cross-sections that satisfy both (i) and (ii) is preferably from 95% by number to 100% by number, and more preferably from 97% by number to 100% by number.

Furthermore, it is preferable that among the cross-sections of the toner, the proportion of cross-sections in which the area ratio of the domains C is from 15% by area to 25% by area based on the area of the cross-section be 90% or more by number. More preferably from 90% by number to 100% by number, and even more preferably from 92% by number to 100% by number. Within these ranges, the eraser abrasion resistance is more likely to be improved.

Furthermore, among domains C, domains with a major axis of 400 nm or more are referred to as domains E. It is preferable that the proportion of toner cross-sections in which 4 to 20 domains E are present per cross-section of one toner particle be 90% or more by number. Within this range, the eraser abrasion resistance is further improved. The proportion of such cross-sections is preferably from 92% by number to 100% by number, and more preferably from 94% by number to 100% by number.

The proportion of such cross-sections can be easily set within the above range by controlling the proportion of crystalline components in crystalline resin A, the proportion of components in amorphous resin B that have a high affinity with crystalline resin A, and also the ratio of crystalline resin A and amorphous resin B. Specifically, the proportion of such cross-sections can be easily set within the above range by increasing the proportion of crystalline components in crystalline resin A, decreasing the proportion of components in amorphous resin B that have a high affinity with crystalline resin A, and decreasing the ratio of crystalline resin A.

Furthermore, it is preferable that the number of domains D present in any 1 μm square region except for the domains C be 100 or more. This state means that domains D are present uniformly to a certain extent in the toner particle, which makes it easier to improve the eraser abrasion resistance.

In order to satisfy the above (i) and “the proportion of cross-sections in which the area ratio of the domains C is from 15% by area to 25% by area based on the area of the cross-section”, there is a means for controlling the number and area of domains C. The number and area of domains C can be controlled by the easiness of compatibility of amorphous resin B with crystalline resin A. Where amorphous resin B is made easily compatible with crystalline resin A, the number of domains C tends to be small and the area thereof also tends to be small. To achieve this, for example, a method can be used that uses a material having a common structural unit that reduces the SP value difference between crystalline resin A and amorphous resin B.

Meanwhile, where amorphous resin B is made less compatible with crystalline resin A, the number of domains C can be increased and the area thereof can also be increased. To achieve this, for example, there is a method of increasing the difference in SP value between crystalline resin A and amorphous resin B, and minimizing the use of materials that have common structural units.

The toner particle contains crystalline resin A and amorphous resin B. The toner particle contains crystalline resin A and amorphous resin B, for example, as a binder resin. Crystalline resin A will be described hereinbelow. Examples of crystalline resin A include vinyl resins, polyester resins, polyurethane resins, and epoxy resins that have crystallinity, but vinyl resins that have crystallinity are preferred.

Where crystalline resin A is a vinyl resin that has crystallinity, it is preferred that crystalline resin A have a monomer unit represented by the following formula (1) (hereinafter also referred to as monomer unit (a)).

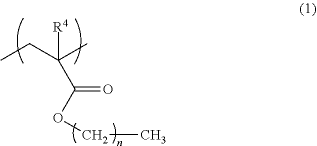

In formula (1), R⁴ represents a hydrogen atom or a methyl group, and n represents an integer from 15 to 35.

Formula (1) indicates that the vinyl resin has a long-chain alkyl group, and when n in formula (1) is from 15 to 35, the vinyl resin is more likely to exhibit crystallinity. n is preferably from 17 to 29.

As a method for introducing the monomer unit (a), there is a method of polymerizing the following (meth)acrylic acid esters. For example, (meth)acrylic acid esters having a linear alkyl group with 16 to 36 carbon atoms [stearyl (meth)acrylate, nonadecyl (meth)acrylate, eicosyl (meth)acrylate, heneicosanyl (meth)acrylate, behenyl (meth)acrylate, lignoceryl (meth)acrylate, ceryl (meth)acrylate, octacosyl (meth)acrylate, myristyl (meth)acrylate, dotriacontyl (meth)acrylate, etc.] and (meth)acrylic acid esters having a branched alkyl group with 18 to 36 carbon atoms [2-decyltetradecyl (meth)acrylate etc.] can be mentioned.

The monomer unit represented by formula (1) may be used alone, or two or more types thereof may be used in combination.

When the crystalline resin A is a vinyl resin having crystallinity, it is possible to have other monomer units in addition to the monomer unit (a). One method for introducing the other monomer units is to polymerize the (meth)acrylic acid ester with other vinyl monomers. The other monomer units may be used alone or in combination of two or more.

Examples of other vinyl monomers include the following.

Styrene, α-methylstyrene, (meth)acrylic acid esters such as methyl (meth)acrylate, ethyl (meth)acrylate, n-butyl (meth)acrylate, t-butyl (meth)acrylate, and 2-ethylhexyl (meth)acrylate.

Monomers having a urea group: for example, monomers obtained by reacting an amine having from 3 to 22 carbon atoms [primary amines (such as normal butylamine, t-butylamine, propylamine, and isopropylamine), secondary amines (such as di-normal ethylamine, di-normal propylamine, and di-normal butylamine), aniline, and cyclohexylamine] with an isocyanate having from 2 to 30 carbon atoms and an ethylenically unsaturated bond by using a known method.

Monomers having a carboxy group: for example, methacrylic acid, acrylic acid, and 2-carboxyethyl (meth)acrylate.

Monomers having a hydroxy group: for example, 2-hydroxyethyl (meth)acrylate and 2-hydroxypropyl (meth)acrylate.

Monomers having an amide group: for example, acrylamide and monomers obtained by reacting an amine having from 1 to 30 carbon atoms with a carboxylic acid having from 2 to 30 carbon atoms and an ethylenically unsaturated bond (such as acrylic acid and methacrylic acid) by using a known method.

Monomers having a lactam structure; for example, N-vinyl-2-pyrrolidone.

Among these, it is preferable that crystalline resin A contain a monomer unit having a lactam structure, and it is more preferable that crystalline resin A contain a monomer unit having a five-membered ring lactam structure. It is preferable to use N-vinyl-2-pyrrolidone as a monomer having a five-membered ring lactam structure. When crystalline resin A has a lactam structure, the affinity between crystalline resin A and paper is improved, and it is easier to further improve the eraser abrasion resistance.

The monomer unit having a lactam structure may be a monomer unit represented by the following formula (L) (preferably formula (L-1)). Crystalline resin A preferably contains from 1.0% by mass to 15.0% by mass, and more preferably contains from 4.0% by mass to 12.0% by mass of the monomer unit represented by formula (L) (preferably formula (L-1)).

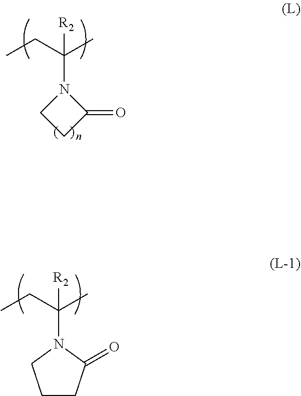

In formulas (L) and (L-1), R² represents a hydrogen atom or a methyl group. n is an integer of from 1 to 4 (preferably from 1 to 3).

When crystalline resin A is a vinyl resin having crystallinity, the content ratio of the monomer unit (a) in the vinyl resin having crystallinity is preferably from 45.0% by mass to 90.0% by mass, more preferably from 50.0% by mass to 80.0% by mass, and even more preferably from 60.0% by mass to 70.0% by mass.

When the content ratio of the monomer unit (a) is within the above ranges, it becomes easier to control the size and number of the domains C and D.

Crystalline resin A may also contain a monomer unit based on styrene. Crystalline resin A preferably contains from 3.0% by mass to 25.0% by mass, and more preferably contains from 10.0% by mass to 20.0% by mass of the monomer unit based on styrene.

Crystalline resin A may also contain a monomer unit based on at least one selected from the group consisting of acrylonitrile and methacrylonitrile. Crystalline resin A preferably contains from 5.0% by mass to 25.0% by mass, and more preferably contains from 8.0% by mass to 17.0% by mass of the monomer unit based on at least one selected from the group consisting of acrylonitrile and methacrylonitrile.

Crystalline resin A may also be a polyester resin. The polyester resin may be a condensation polymer of a divalent or higher polyvalent carboxylic acid and a polyhydric alcohol.

Examples of the polyvalent carboxylic acid include the following compounds.

Dibasic acids such as succinic acid, adipic acid, sebacic acid, phthalic acid, isophthalic acid, terephthalic acid, malonic acid, and dodecenylsuccinic acid, as well as anhydrides thereof and lower alkyl esters thereof, and aliphatic unsaturated dicarboxylic acids such as maleic acid, fumaric acid, itaconic acid, and citraconic acid.

Also, 1,2,4-benzenetricarboxylic acid, 1,2,5-benzenetricarboxylic acid, as well as anhydrides thereof and lower alkyl esters thereof. These may be used alone or in combination of two or more.

Examples of the polyhydric alcohol include the following compounds.

Alkylene glycols (ethylene glycol, 1,2-propylene glycol, and 1,3-propylene glycol); alkylene ether glycols (polyethylene glycol and polypropylene glycol); alicyclic diols (1,4-cyclohexanedimethanol); bisphenols (bisphenol A); and alkylene oxide (ethylene oxide and propylene oxide) adducts of alicyclic diols. The alkyl portion of the alkylene glycol and alkylene ether glycol may be linear or branched.

Also, glycerin, trimethylolethane, trimethylolpropane, and pentaerythritol. These may be used alone or in combination of two or more.

In addition, monovalent acids such as acetic acid and benzoic acid, and monohydric alcohols such as cyclohexanol and benzyl alcohol may also be used as necessary for the purpose of adjusting the acid value and hydroxyl value.

There are no particular limitations on the method for producing the polyester resin, and for example, an ester exchange method and a direct polycondensation method may be used alone or in combination.

The weight-average molecular weight Mw of crystalline resin A is preferably from 15,000 to 50,000, more preferably from 20,000 to 40,000. Further, the value Mw/Mn of the ratio of the weight-average molecular weight Mw of crystalline resin A to the number-average molecular weight Mn is preferably from 2.0 to 6.5, more preferably from 2.5 to 5.5.

The content ratio of crystalline resin A in the binder resin is preferably from 10.0% by mass to 70.0% by mass. Within the above range, it becomes easier to obtain a domain-matrix structure, and it becomes easier to control the size and number of domains C and D. The content ratio of crystalline resin A in the binder resin is more preferably from 15.0% by mass to 60.0% by mass, even more preferably from 20.0% by mass to 50.0% by mass, still more preferably from 30.0% by mass to 40.0% by mass, and particularly preferably from 33.0% by mass to 37.0% by mass.

Amorphous resin B will be described hereinbelow. Examples of amorphous resin B include vinyl resins, polyester resins, polyurethane resins, and epoxy resins. Amorphous resin B is preferably a vinyl resin or a polyester resin, and more preferably a vinyl resin.

When amorphous resin B is a vinyl resin, it is preferable that amorphous resin B have a monomer unit (d) represented by the following formula (2). In formula (2), R⁵ represents a hydrogen atom or a methyl group, and m represents an integer of from 3 to 35.

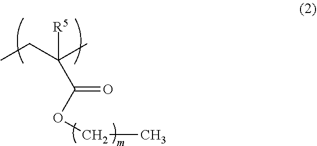

Where amorphous resin B has the monomer unit (d), it becomes easier to control the compatibility between amorphous resin B and crystalline resin A, it becomes easier to form a domain-matrix structure, and it becomes easier to control the size and number of domains C and D.

The preferred range of m is from 3 to 29, more preferably from 3 to 19, even more preferably from 3 to 15, and still more preferably from 3 to 5.

As a method for introducing the monomer unit (d), there is a method of polymerizing the following (meth)acrylic acid esters in addition to the (meth)acrylic acid esters usable for the monomer unit (a) described above. Examples include n-butyl (meth)acrylate, hexyl (meth)acrylate, octyl (meth)acrylate, decyl (meth)acrylate, lauryl (meth)acrylate, myristyl (meth)acrylate, and palmityl (meth)acrylate.

The monomer unit (d) may be used alone or in combination of two or more types.

When amorphous resin B is a vinyl resin, it is possible to have other monomer units in addition to the monomer unit (d). As a method for introducing other monomer units, there is a method of polymerizing the (meth)acrylic acid ester and the vinyl monomer usable for crystalline resin A described above.

When amorphous resin B is a vinyl resin, the proportion of the monomer unit (d) is preferably from 5.0% to 40.0% by mass. The lower limit is more preferably 10.0% by mass or more, even more preferably 13.0% by mass or more, and still more preferably 15.0% by mass or more. The upper limit is more preferably 35.0% by mass or less, even more preferably 30.0% by mass or less, and still more preferably 20.0% by mass or less.

Furthermore, amorphous resin B may contain a monomer unit based on styrene. Amorphous resin B preferably contains from 50.0% by mass to 95.0% by mass and more preferably from 60.0% by mass to 80.0% by mass of the monomer unit based on styrene.

When amorphous resin B is a polyester resin, a resin that does not exhibit crystallinity can be used among the polyester resins that can be obtained by the reaction of the above-mentioned divalent or higher polyvalent carboxylic acid and polyhydric alcohol.

The toner preferably has a weight-average molecular weight (Mw) of tetrahydrofuran (THF)-soluble matter measured by gel permeation chromatography (GPC) of from 10,000 to 200,000. The lower limit is more preferably 30,000 or more, and even more preferably 50,000 or more. The upper limit is more preferably 180,000 or less. With Mw within the above range, the durability of the toner is likely to be improved.

Furthermore, the value (Mw/Mn) of the ratio of the weight-average molecular weight (Mw) of the THF-soluble matter of the toner to the number-average molecular weight (Mn) is preferably from 5.0 to 15.0, and more preferably from 7.0 to 12.0.

The toner has a weight-average particle size of from 4.0 μm to 10.0 μm. With the weight-average particle size in the above range, it is possible to achieve both low-temperature fixability and high gloss over a wide temperature range. The weight-average particle size of the toner is preferably from 5.0 μm to 9.0 μm, more preferably from 5.3 μm to 8.5 μm.

The melting point derived from crystalline resin A in the differential scanning calorimeter (DSC) measurement of the toner is preferably from 50° C. to 80° C. With the melting point derived from crystalline resin A in the above range, it becomes easier to improve the low-temperature fixability. The preferred range of the melting point is from 55° C. to 75° C., more preferably from 57° C. to 70° C.

The toner may contain a release agent. The release agent is at least one selected from the group consisting of hydrocarbon waxes and ester waxes. By using a hydrocarbon wax and/or an ester wax, it becomes easier to ensure effective release property. The release agent preferably contains an ester wax, more preferably contains a polyfunctional ester wax. The polyfunctional ester wax improves the abrasion resistance and gloss at high temperatures.

The polyfunctional ester wax refers to an ester compound of a polyhydric alcohol and a monocarboxylic acid, and an ester compound of a polycarboxylic acid and a monohydric alcohol. The polyfunctional ester wax is preferably at least one ester compound selected from the group consisting of an ester compound of a tetrahydric to octahydric alcohol and an aliphatic monocarboxylic acid, and an ester compound of a tetravalent to octavalent carboxylic acid and an aliphatic monohydric alcohol. More preferably, the polyfunctional ester wax is at least one ester compound selected from the group consisting of an ester compound of a hexahydric to octahydric alcohol and an aliphatic monocarboxylic acid, and an ester compound of a hexavalent to octavalent carboxylic acid and an aliphatic monohydric alcohol.

The hydrocarbon wax is not particularly limited, and examples thereof include the following.

Aliphatic hydrocarbon waxes: low molecular weight polyethylene, low molecular weight polypropylene, low molecular weight olefin copolymer, Fischer-Tropsch wax, or waxes obtained by oxidizing or adding acid to these.

The ester wax may have at least one ester bond in one molecule, and either natural ester wax or synthetic ester wax may be used.

The ester wax is not particularly limited, and examples thereof include the following.

Esters of monohydric alcohols and monocarboxylic acids such as behenyl behenate, stearyl stearate, and palmityl palmitate;
esters of divalent carboxylic acids and monohydric alcohols such as dibehenyl sebacate;
esters of dihydric alcohols and monocarboxylic acids such as ethylene glycol distearate and hexanediol dibehenate;
esters of trihydric alcohols and monocarboxylic acids such as glycerin tribehenate;
esters of tetrahydric alcohols and monocarboxylic acids such as pentaerythritol tetrastearate and pentaerythritol tetrapalmitate;
esters of hexahydric alcohols and monocarboxylic acids such as dipentaerythritol hexastearate, dipentaerythritol hexapalmitate, and dipentaerythritol hexabehenate;
esters of polyhydric alcohols and monocarboxylic acids such as polyglycerin behenate; and
natural ester waxes such as carnauba wax and rice wax.

Among these, at least one compound selected from the group including esters of hexahydric alcohols and monocarboxylic acids such as dipentaerythritol hexastearate, dipentaerythritol hexapalmitate, and dipentaerythritol hexabehenate, and esters of octahydric alcohols and monocarboxylic acids such as tripentaerythritol octastearate, tripentaerythritol octapalmitate, and tripentaerythritol octabehenate are preferred.

As the release agent, a hydrocarbon wax or an ester wax may be used alone, or a combination of a hydrocarbon wax and an ester wax may be used, or two or more of each may be mixed together.

In the toner, the content of the release agent in the toner particle is preferably from 1.0% by mass to 30.0% by mass, more preferably from 2.0% by mass to 25.0% by mass, even more preferably from 5.0% by mass to 15.0% by mass, and still more preferably from 6.0% by mass to 13.0% by mass. When the content of the release agent in the toner particle is within the above range, it becomes easier to obtain the effects of abrasion resistance and high gloss at high temperatures.

The melting point of the release agent is preferably from 60° C. to 120° C. When the melting point of the release agent is within the above range, the release agent melts during fixing and easily out-migrates onto the toner particle surface, making it easier to exhibit releasability. The melting point of the release agent is more preferably from 70° C. to 100° C.

The toner may contain a colorant. Examples of the colorant include known organic pigments, organic dyes, inorganic pigments, carbon black as a black colorant, magnetic particles, and the like. In addition, colorants that have been used in the conventional toners may be used.

Examples of yellow colorants include the following: condensed azo compounds, isoindolinone compounds, anthraquinone compounds, azo metal complexes, methine compounds, and allylamide compounds. Specifically, C. I. Pigment Yellow 12, 13, 14, 15, 17, 62, 74, 83, 93, 94, 95, 109, 110, 111, 128, 129, 147, 155, 168, and 180 are preferably used.

Examples of magenta colorants include the following: condensed azo compounds, diketopyrrolopyrrole compounds, anthraquinone compounds, quinacridone compounds, basic dye lake compounds, naphthol compounds, benzimidazolone compounds, thioindigo compounds, and perylene compounds.

Specifically, C. I. Pigment Red 2, 3, 5, 6, 7, 23, 48:2, 48:3, 48:4, 57:1, 81:1, 122, 144, 146, 166, 169, 177, 184, 185, 202, 206, 220, 221, and 254 are preferably used.

Examples of cyan colorants include the following: copper phthalocyanine compounds and derivatives thereof, anthraquinone compounds, and basic dye lake compounds. Specifically, C. I. Pigment Blue 1, 7, 15, 15:1, 15:2, 15:3, 15:4, 60, 62, and 66 are preferably used.

The colorant is selected from the viewpoint of hue angle, chroma, lightness, lightfastness, OHP transparency, and dispersibility in the toner.

The content of the colorant is preferably from 1.0 part by mass to 20.0 parts by mass per 100.0 parts by mass of the binder resin. When magnetic particles are used as the colorant, the content is preferably from 40.0 parts by mass to 150.0 parts by mass per 100.0 parts by mass of the binder resin.

A charge control agent may be included in the toner particle as necessary. Also, the charge control agent may be added externally to the toner particle. By blending the charge control agent, the charge characteristics can be stabilized, and it becomes possible to control the optimal triboelectric charge quantity according to the development system.

A known charge control agent can be used, and a charge control agent that has a particularly fast charging rate and can stably maintain a constant charge quantity is preferable.

As charge control agents that control the toner to be negatively chargeable, the following can be mentioned.

Organometallic compounds and chelate compounds are effective, and examples of the charge control agents include monoazo metallic compounds, acetylacetone metallic compounds, and metallic compounds of aromatic hydroxycarboxylic acids, aromatic dicarboxylic acids, hydroxycarboxylic acids, and dicarboxylic acid systems.

Examples of agents that control the toner to be positively chargeable include the following.

Nigrosine, quaternary ammonium salts, metal salts of higher fatty acids, diorganotinborates, guanidine compounds, and imidazole compounds can be mentioned.

The content of the charge control agent is preferably from 0.01 parts by mass to 20.0 parts by mass, and more preferably from 0.5 parts by mass to 10.0 parts by mass, per 100.0 parts by mass of toner particles.

The toner particles may be used as they are as toner or may be used as toner by mixing with an external additive etc., as necessary, and attaching it to the toner particle surface.

Examples of the external additive include inorganic fine particles selected from the group consisting of silica fine particles, alumina fine particles, and titania fine particles, or composite oxides thereof. Examples of composite oxides include silica aluminum fine particles and strontium titanate fine particles.

The content of the external additive is preferably from 0.01 parts by mass to 8.0 parts by mass, and more preferably from 0.1 parts by mass to 4.0 parts by mass, per 100 parts by mass of toner particles.

The toner particles may be manufactured by any conventional method such as suspension polymerization, emulsion aggregation, dissolution suspension, or pulverization within the scope of the present case. However, it is preferable to manufacture the toner particles by suspension polymerization.

The suspension polymerization method will be described hereinbelow in detail.

For example, crystalline resin A synthesized in advance is mixed with polymerizable monomers that produces amorphous resin B. If necessary, other materials such as a colorant, a release agent, and a charge control agent are also mixed and uniformly dissolved or dispersed to prepare a polymerizable monomer composition.

Then, the polymerizable monomer composition is dispersed in an aqueous medium using a stirrer or the like to prepare suspended particles of the polymerizable monomer composition. The polymerizable monomers contained in the particles are then polymerized by an initiator or the like to obtain toner particles.

After polymerization is completed, the toner particles are filtered, washed and dried by known methods, and an external additive is added as necessary to obtain the toner.

The polymerization initiator may be a known polymerization initiator.

Examples thereof include azo or diazo polymerization initiators such as 2,2′-azobis-(2,4-dimethylvaleronitrile), 2,2′-azobisisobutyronitrile, 1,1′-azobis (cyclohexane-1-carbonitrile), 2,2′-azobis-4-methoxy-2,4-dimethylvaleronitrile, and azobisisobutyronitrile; and peroxide polymerization initiators such as benzoyl peroxide, t-butyl peroxy-2-ethylhexanoate, t-butyl peroxypivalate, t-butyl peroxyisobutyrate, t-butyl peroxyneodecanoate, methyl ethyl ketone peroxide, diisopropyl peroxycarbonate, cumene hydroperoxide, 2,4-dichlorobenzoyl peroxide, and lauroyl peroxide.

In addition, known chain transfer agents and polymerization inhibitors may be used.

The aqueous medium may contain an inorganic or organic dispersion stabilizer. Known dispersion stabilizers can be used as the dispersion stabilizer.

Examples of inorganic dispersion stabilizers include phosphates such as hydroxyapatite, tricalcium phosphate, dicalcium phosphate, magnesium phosphate, aluminum phosphate, and zinc phosphate; carbonates such as calcium carbonate and magnesium carbonate; metal hydroxides such as calcium hydroxide, magnesium hydroxide, and aluminum hydroxide; sulfates such as calcium sulfate and barium sulfate; calcium metasilicate; bentonite; silica; and alumina.

Meanwhile, examples of organic dispersion stabilizers include polyvinyl alcohol, gelatin, methyl cellulose, methylhydroxypropyl cellulose, ethyl cellulose, sodium salt of carboxymethyl cellulose, polyacrylic acid and salts thereof, and starch.

When an inorganic compound is used as the dispersion stabilizer, a commercially available product may be used as it is, but in order to obtain finer particles, the inorganic compound may be generated in an aqueous medium and used.

For example, in the case of calcium phosphate such as hydroxyapatite or tricalcium phosphate, an aqueous solution of phosphate may be mixed with an aqueous solution of calcium salt under high agitation.

The aqueous medium may contain a surfactant. Known surfactants can be used as the surfactant. Examples thereof include anionic surfactants such as sodium dodecylbenzene sulfate and sodium oleate; cationic surfactants; amphoteric surfactants; and nonionic surfactants.

Methods for calculating and measuring various physical properties of toner and toner materials are described below.

### Method for Observing Cross Section of Toner in Transmission Electron Microscope (TEM) and Measuring Major Axis and Number of Domains

The domain-matrix structure is observed after staining the cross-section of the toner with ruthenium.

First, the toner is spread onto a cover glass (Matsunami Glass Co., Ltd., square cover glass No. 1) in a single layer. Then, an Os film (5 nm) and a naphthalene film (20 nm) are applied to the toner as protective films using an osmium plasma coater (Filgen, Inc., OPC80T).

Next, a PTFE tube (inner diameter @1.5 mm× outer diameter @3 mm×3 mm) is filled with photocurable resin D800 (JEOL Ltd.), and the above-mentioned cover glass is gently placed on top of the tube in a direction such that the toner is in contact with the photocurable resin D800. In this state, the resin is cured by irradiation with light, and then the cover glass and the tube are removed to form a cylindrical resin with the toner embedded in the outermost surface.

Using an ultrasonic ultramicrotome (Leica, UC7) at a cutting speed of 0.6 mm/s, the cylindrical resin is cut from the outermost surface, the cutting depth being the radius of the toner (4.0 μm when the weight-average particle size (D4) is 8.0 μm), to expose the cross-section of the toner. Next, a thin slice sample of the toner cross-section is produced by cutting to a film thickness of 250 nm. By cutting in this manner, the cross-section of the central part of the toner can be obtained.

The obtained thin slice sample is stained for 15 min in an atmosphere of RuO₄ gas at 500 Pa using a vacuum electronic staining device (Filgen, Inc., VSC4R1H), and STEM observation is performed using a TEM (JEOL, JEM2800). The probe size in the STEM observation is 1 nm, and the image size is 1024×1024 pixels.

The bright-field images obtained are binarized using the image processing software “Image-ProPlus (manufactured by Media Cybernetics, Inc).” In this binarization process, when the change in brightness from black to white is taken as from 0 gradations to 255 gradations, the portion at or below 127 gradations is taken as black and the portion at or above 128 gradations is taken as white.

In the cross-sectional observation of the toner, the portions containing crystalline resin A are shown in black when the binarization process is performed, and the portions containing amorphous resin B are shown in white when the binarization process is performed.

From the images obtained by STEM observation after the binarization process, it is determined whether a domain-matrix structure is observed in the cross-section of the toner. It is also determined whether the domains and matrix contain crystalline resin A or amorphous resin B. Where the ratio of the cross-sections of particles in which a domain-matrix structure has been formed to the cross-section of the toner is 80% or more by number, the cross-section of the toner under measurement is determined to have a domain-matrix structure. A state in which domains, which are discontinuous phases, are dispersed in a matrix, which is a continuous phase, is considered to be a domain-matrix structure.

Next, the toner particles to be observed for measuring the major axis of the domains are selected as follows. First, the cross-sectional area of the toner particles is obtained from the cross-sectional image of the toner particles, and the diameter of a circle having an area equal to the cross-sectional area (circle-equivalent diameter) is obtained. The toner particles to be observed are those for which the absolute value of the difference between this circle-equivalent diameter and the weight-average particle diameter (D4) of the toner is 1.0 μm or less. Then, 100 toner particles to be observed are selected.

Next, the major axis of the domains (white areas when the domains are amorphous resin B) observed in the cross-section of the toner particles selected for observation is measured. Of these, a domain with a major axis of 300 nm or more is referred to as domain C, and a domain with a major axis of 200 nm or less is referred to as domain D. The number-average major axis of domains D is calculated for 100 toner particles.

Also the proportion of the cross-sections which satisfy both (i) and (ii) is calculated.
(i) from 5 to 20 domains C are present per cross-section of one toner particle, and the area ratio of domains C is from 10% by area to 30% by area based on the area of the cross-section;
(ii) domains D are observed over an entire region of a region except for the domain C in the cross-section.

Here, whether domains D are observed over the entire region is determined in the following manner. Three 1 μm square areas except for domains C on the cross-section of the toner particle are selected. Where the number of domains D in all three 1 μm square areas is 30 or more, it is determined that “domains D are observed over the entire region.”

The proportion of cross-sections in which the area ratio of the domains C is from 15% by area to 25% by area based on the area of the cross-section of the toner is calculated. Furthermore, among domains C, those with a major axis of 400 nm or more are referred to as domains E. The proportion of cross-sections in which 4 to 20 domains E are present per toner particle is calculated.

Additionally, any 1 μm square region except for domains C on the cross-section of the toner particle is selected, and the number of domains D in the 1 μm square region is calculated. The arithmetic average value of 100 particles under observation is adopted.

### Principle of Ruthenium Staining

When ruthenium staining is performed on the cross-section of a toner particle, the crystalline resin component is stained with ruthenium more than the amorphous resin component, so the contrast becomes clearer, and the cross-section of the toner particle is easier to observe. This is because RuO₄ has a strong oxidizing power and oxidizes the long-chain alkyl and alkylene that increase the crystallinity, and as a result, the crystalline resin component is stained more strongly than the amorphous resin component.

The more crystalline the resin component, the more ruthenium atoms are present therein, and the more ruthenium atoms are present, the lower is the electron beam transmission. Therefore, resin components with higher crystallinity are observed to be more strongly stained in electron microscope images. Conversely, amorphous resin components are observed to be weakly stained or not stained at all. From this, it can be determined that the strongly stained portions are portions that contain crystalline resin, and the weakly stained portions or portions that are not stained are portions that contain amorphous resin.

### Method for Measuring Weight-Average Particle Diameter (D4) of Toner

The weight-average particle diameter (D4) of toner is calculated in the following manner. The measuring device used is a precision particle size distribution measuring device using pore electrical resistance method, “Coulter Counter Multisizer 3” (registered trademark, manufactured by Beckman Coulter, Inc.), equipped with a 100 μm aperture tube. The measurement conditions are set and the measurement data is analyzed using the dedicated software “Beckman Coulter Multisizer 3 Version 3.51” (manufactured by Beckman Coulter, Inc.) provided with the device. The measurement is performed with an effective measurement channel number of 25,000 channels.

The aqueous electrolytic solution that can be used for the measurement is prepared by dissolving special grade sodium chloride in ion-exchanged water to a concentration of approximately 1% by mass. For example, “ISOTON II” (manufactured by Beckman Coulter, Inc.) can be used. Before the measurement and analysis, the dedicated software is set as follows.

In the “Change Standard Measurement Method (SOMME)” screen of the dedicated software, the total count number in the control mode is set to 50,000 particles, the number of measurements is set to 1, and the Kd value is set to the value obtained using “Standard Particle 10.0 μm” (manufactured by Beckman Coulter, Inc.). The threshold and noise level are automatically set by pressing the “Threshold/Noise Level Measurement Button”. In addition, the current is set to 1600 μA, the gain is set to 2, the electrolytic solution is set to ISOTON II, and “Flush Aperture Tube After Measurement” is checked.

In the “Pulse to Particle Size Conversion Setting” screen of the dedicated software, the bin interval is set to logarithmic particle size, the particle size bin is set to 256 particle size bins, and the particle size range is set to from 2 μm to 60 μm. The specific measurement method is as follows.
(1) About 200 ml of the aqueous electrolytic solution is poured into a dedicated 250 ml round-bottom glass beaker of the Multisizer 3, the glass beaker is set on the sample stand, and stirring is performed with a stirrer rod counterclockwise at 24 revolutions per second. Then, the “Aperture Tube Flush” function of the dedicated software is used to remove dirt and air bubbles from inside the aperture tube.
(2) A total of 30 ml of the aqueous electrolytic solution is poured into a 100 ml flat-bottom glass beaker. Then, 0.3 ml of a solution of “Contaminon N” (a 10% by mass aqueous solution of a neutral detergent for cleaning precision measuring instruments, pH 7, made of a nonionic surfactant, an anionic surfactant, and an organic builder, manufactured by Wako Pure Chemical Industries, Ltd.) diluted 3-fold by mass with ion-exchanged water is added as a dispersant to the aqueous electrolytic solution.
(3) An ultrasonic disperser “Ultrasonic Dispersion System Tetra 150” (manufactured by Nikkaki Bios Co., Ltd.) with an electrical output of 120 W and two oscillators with an oscillation frequency of 50 kHz built in with a phase shift of 180 degrees is prepared. A total of 3.3 L of ion-exchanged water is poured into the water tank of the ultrasonic disperser and 2 ml of Contaminon N is added to this water tank.
(4) The beaker from (2) is set in the beaker fixing hole of the ultrasonic disperser, and the ultrasonic disperser is actuated. The height position of the beaker is adjusted so that the resonance state of the aqueous electrolytic solution in the beaker is maximized.
(5) While the aqueous electrolytic solution in the beaker of (4) is irradiated with ultrasonic waves, 10 mg of toner is added little by little to the aqueous electrolytic solution and dispersed. Then, ultrasonic dispersion processing is continued for another 60 sec. In addition, during ultrasonic dispersion, the water temperature of the water tank is adjusted, as appropriate, to be from 10° C. to 40° C.
(6) The aqueous electrolytic solution of (5) in which the toner has been dispersed is dropped using a pipette into the round-bottom beaker of (1) placed in the sample stand, and the measured concentration is adjusted to about 5%. Then, the measurement is continued until the number of measured particles reaches 50,000.
(7) The measurement data are analyzed using the dedicated software provided with the device, and the weight-average particle size (D4) is calculated. In addition, when the dedicated software is set to graph/volume %, the “Average Diameter” on the “Analysis/Volume Statistics (Arithmetic Mean)” screen is the weight-average particle size (D4).

### Method for Measuring Melting Point of Crystalline Resin a in Differential Scanning Calorimetry (DSC) Measurement of Toner

The melting point of the toner is measured using a DSC Q2000 (manufactured by TA Instruments) under the following conditions.
Temperature rise rate: 10° C./min
Measurement start temperature: 20° C.
Measurement end temperature: 180° C.

The melting points of indium and zinc are used for temperature correction of the device detection unit, and the heat of fusion of indium is used for heat quantity correction.

Specifically, 5 mg of the sample is weighed out and placed in an aluminum pan, and differential scanning calorimetry is performed. An empty silver pan is used as a reference. During the temperature rise process, the temperature is raised to 180° C. at a rate of 10° C./min. The peak temperature is then calculated from each peak.

When the maximum endothermic peak, i.e., the endothermic peak thought to be derived from crystalline resin A, does not overlap with other endothermic peaks, e.g., of the release agent, the temperature at the maximum endothermic peak is taken as the melting point of the toner.

Meanwhile, when other endothermic peaks, e.g., of the release agent, overlap with the maximum endothermic peak, it is necessary to subtract the endothermic peak derived from the release agent and the like.

For example, the endothermic peak derived from crystalline resin A can be obtained by subtracting the endothermic quantity derived from the release agent by using the following method.

First, a separate DSC measurement is performed on the release agent alone to determine endothermic characteristics thereof. Next, the content of the release agent contained in the toner is determined. The content of the release agent in the toner can be measured by known structural analysis. After that, the endothermic quantity due to the release agent is calculated from the content of the release agent in the toner, and this quantity can be subtracted from the peak derived from the binder resin.

Where the release agent is readily compatible with the binder resin component, it is necessary to multiply the content of the release agent by the compatibility rate and then calculate and subtract the endothermic quantity due to the release agent. The compatibility rate is calculated by dividing the endothermic quantity determined for a mixture obtained by melt mixing the molten mixture of resin components and the release agent in the same ratio as the content ratio of the release agent by the theoretical amount of endothermic quantity calculated from the endothermic quantity of the melt mixture determined in advance and the endothermic quantity of the release agent alone.

### Method for Measuring Molecular Weight of Toner

The molecular weight (weight-average molecular weight Mw) of the THF-soluble matter of the toner is measured by gel permeation chromatography (GPC) in the following manner.

First, the toner is dissolved in tetrahydrofuran (THF) at room temperature for 24 hours. The resulting solution is then filtered through a solvent-resistant membrane filter “Myshori Disc” (manufactured by Tosoh Corporation) with a pore size of 0.2 μm to obtain a sample solution. The sample solution is adjusted so that the concentration of components soluble in THF is 0.8% by mass. This sample solution is used to perform measurements under the following conditions.
Apparatus: HLC8120 GPC (detector: RI) (manufactured by Tosoh Corporation)
Columns: Shodex KF-801, 802, 803, 804, 805, 806, 807 (manufactured by Showadenkosya Co., Ltd.)
Eluent: tetrahydrofuran (THF)
Flow rate: 1.0 ml/min
Oven temperature: 40.0° C.
Sample injection volume: 0.10 ml

In calculating the molecular weight of the sample, a molecular weight calibration curve created using standard polystyrene resins (for example, product names “TSK Standard Polystyrene F-850, F-450, F-288, F-128, F-80, F-40, F-20, F-10, F-4, F-2, F-1, A-5000, A-2500, A-1000, A-500”, manufactured by Tosoh Corporation) is used.

Method for Separating Crystalline Resin a and Amorphous Resin B from Toner

Crystalline resin A and amorphous resin B can be separated from toner by known methods, and one example thereof is shown below.

Gradient polymer LC is used as a method of separating resin components from toner. In this analysis, separation can be performed according to the polarity of the resin in the binder resin, regardless of molecular weight.

First, the toner is dissolved in chloroform. The sample is adjusted to a sample concentration of 0.1% by mass in chloroform, and the solution filtered through a 0.45 μm PTFE filter is used for measurement.

The measurement conditions for gradient polymer LC are shown below.
Apparatus: ULTIMATE 3000 (manufactured by Thermo Fisher Scientific Inc.)
Mobile phase: A Chloroform (HPLC), B Acetonitrile (HPLC)
Gradient: 2 min (A/B=0/100)→25 min (A/B=100/0)
(The gradient of the mobile phase change was made linear.)
Flow rate: 1.0 mL/min
Injection: 0.1% by mass×20 μL
Column: Tosoh TSKgel ODS (4.6 mm×150 mm×5 μm)
Column temperature: 40° C.
Detector: Corona Charged Aerosol Detector (Corona-CAD) (manufactured by Thermo Fisher Scientific Inc.)

The resin components can be separated into two peaks according to polarity in the time-intensity graph obtained by the measurement. After that, the above measurement is performed again, and separation into two types of resin can be performed by fractionation at the time when the valleys of the respective peaks are reached.

The separated resins are subjected to DSC measurement, and the resin with a melting point peak is regarded as crystalline resin A, and that without such peak is regarded as amorphous resin B.

When the toner contains a release agent, components with a molecular weight of 3000 or less are separated as the release agent by recycle HPLC. The measurement method is shown below. First, a chloroform solution of toner is prepared using the method described above. The resulting solution is then filtered through a solvent-resistant membrane filter “Myshori Disc” (manufactured by Tosoh Corporation) with a pore size of 0.2 μm to obtain a sample solution. The sample solution is adjusted so that the concentration of components soluble in chloroform is 1.0% by mass. This sample solution is used to perform measurements under the following conditions.
Apparatus: LC-Sakura NEXT (manufactured by Japan Analytical Industry Co., Ltd.)
Column: JAIGEL 2H, 4H (manufactured by Japan Analytical Industry Co., Ltd.)
Eluent: chloroform
Flow rate: 10.0 ml/min
Oven temperature: 40.0° C.
Sample injection volume: 1.0 ml

In calculating the molecular weight of the sample, a molecular weight calibration curve created using standard polystyrene resins (for example, product names “TSK Standard Polystyrene F-850, F-450, F-288, F-128, F-80, F-40, F-20, F-10, F-4, F-2, F-1, A-5000, A-2500, A-1000, A-500”, manufactured by Tosoh Corporation) is used.

From the molecular weight curve obtained in this way, the components with a molecular weight of 3000 or less are repeatedly fractionated and the release agent is removed from the toner. The molecular weight to be fractionated may be changed in consideration of the molecular weight of the release agent.

### Method for Measuring Content Ratio of Various Monomer Units Such as Monomer Unit (a) in Resin and the Number of Carbon Atoms in Alkyl Group

The content ratio of various monomer units (a) and the like in resin and the number of carbon atoms in the alkyl group are measured by 1H-NMR under the following conditions. Crystalline resin A fractionated by the above method can be used as the measurement sample.
Measuring device: FT NMR device JNM-EX400 (manufactured by JEOL Ltd.)
Measurement frequency: 400 MHZ
Pulse condition: 5.0 μs
Frequency range: 10,500 Hz
Number of accumulations: 64
Measurement temperature: 30° C.
Sample: 50 mg of the measurement sample is placed in a sample tube with an inner diameter of 5 mm, deuterated chloroform (CDCl₃) is added as a solvent, and this is dissolved in a thermostatic bath at 40° C. to prepare the sample.

The obtained 1H-NMR chart is analyzed to identify the structure of each monomer unit. Here, as an example, the measurement of the content ratio of monomer unit (a) in crystalline resin A and the number of carbon atoms in the alkyl group is described.

In the obtained 1H-NMR chart, from the peaks attributable to the constituent elements of monomer unit (a), a peak independent of the peaks attributable to the constituent elements of other monomer units is selected, and the integral value S1 of this peak is calculated. The integral values of the other monomer units contained in crystalline resin A are also calculated in the same manner.

When the monomer units constituting crystalline resin A are monomer unit (a) and one other monomer unit, the content ratio of monomer unit (a) is calculated in the following manner by using the integral value S1 and the integral value S2 of the peak of the other monomer unit. Here, n1 and n2 are the number of hydrogen atoms in the constituent elements to which the peak of interest for each segment belongs.

$$Content ratio of monomer unit ( a ) ( mol \% ) = \{ ( S 1 / n 1 ) / ( ( S 1 / n 1 ) + ( S 2 / n 2 ) ) \} \times 100.$$

Even if there are two or more types of other monomer units, the content ratio of monomer unit (a) can be calculated in the same way (using S3 . . . . Sx, n3 . . . nx).

Also, the number of carbon atoms in the alkyl group can be calculated from the integral ratio of the proton peak in the 1H-NMR chart.

When a polymerizable monomer that does not contain hydrogen atoms in constituent elements other than the vinyl group is used, the measurement atomic nucleus is set to ¹³C using ¹³C-NMR, measurement is performed in a single pulse mode, and calculation is performed in the same way as with ¹H-NMR. The ratio of each monomer unit (mol %) calculated by the above method is multiplied by the molecular weight of each monomer unit to convert the content ratio of each monomer unit to % by mass. The same method is used for measurement of amorphous resin B.

### EXAMPLES

The present disclosure will be specifically explained below using examples, but these are not intended to limit the present disclosure in any way. In the following formulations, parts are by weight unless otherwise specified.

### Preparation of Crystalline Resin A1

The following materials were placed in a reaction vessel equipped with a reflux condenser, a stirrer, a thermometer, and a nitrogen introduction tube under a nitrogen atmosphere.

| | |
|---|---|
| Toluene | 100.0 parts |
| Monomer composition | 100.0 parts |
| (The monomer composition is a mixture of the | |
| following monomers in the ratio shown below) | |
| (Behenyl acrylate | 65.0 parts) |
| (Styrene | 15.0 parts) |
| (Methacrylonitrile | 10.0 parts |
| (N-vinyl-2-pyrrolidone | 10.0 parts) |
| Polymerization initiator: t-butyl peroxypivalate | 0.5 parts |
| (Perbutyl PV, manufactured by NOF Corp.) | |

The inside of the reaction vessel was heated to 70° C. while stirring at 200 rpm, and polymerization reaction was carried out for 12 h, obtaining a solution in which the polymer of the monomer composition was dissolved in toluene. The temperature of the solution was then lowered to 25° C., and the solution was poured into 1000.0 parts of methanol while stirring, to precipitate the methanol-insoluble matter. The resulting methanol-insoluble matter was filtered off, washed with methanol, and then vacuum dried at 40° C. for 24 h to obtain crystalline resin A1. Table 1 shows the physical properties of crystalline resin A1.

### Preparation of Crystalline Resins A2 to A12

Crystalline resins A2 to A12 were prepared in the same manner as crystalline resin A1, except that the amounts of monomer composition and polymerization initiator added were changed to those shown in Table 1. Table 1 shows the physical properties of crystalline resins A2 to A12.

TABLE 1

| | | | | | | | | | | Polymer- | | |
|---|---|---|---|---|---|---|---|---|---|---|---|---|
| | | | | | | | | | | ization | | |
| | Monomer (a) | | | Other monomer 1 | | Other monomer 2 | | Other monomer 3 | | initiator | Molecular | |
| | | Number | Amount | | Amount | | Amount | | Amount | Amount | weight | |
| Crystalline | | of carbon | added | | added | | added | | added | added | | Mw/ |
| resin A | Type | atoms n | (parts) | Type | (parts) | Type | (parts) | Type | (parts) | (parts) | Mw | Mn |
| Crystalline | Behenyl | 21 | 65.0 | Styrene | 15.0 | Methacrylonitrile | 10.0 | N-vinyl-2- | 10.0 | 0.5 | 32300 | 3.3 |
| resin A1 | acrylate | | | | | | | pyrrolidone | | | | |
| Crystalline | Behenyl | 21 | 65.0 | Styrene | 15.0 | Methacrylonitrile | 10.0 | N-vinyl-2- | 10.0 | 0.3 | 38600 | 5.3 |
| resin A2 | acrylate | | | | | | | pyrrolidone | | | | |
| Crystalline | Behenyl | 21 | 65.0 | Styrene | 15.0 | Methacrylonitrile | 13.0 | N-vinyl-2- | 7.0 | 0.5 | 31500 | 3.2 |
| resin A3 | acrylate | | | | | | | pyrrolidone | | | | |
| Crystalline | Behenyl | 21 | 65.0 | Styrene | 15.0 | Methacrylonitrile | 15.0 | N-vinyl-2- | 5.0 | 0.5 | 30900 | 3.1 |
| resin A4 | acrylate | | | | | | | pyrrolidone | | | | |
| Crystalline | Behenyl | 21 | 65.0 | Styrene | 15.0 | Methacrylonitrile | 18.0 | N-vinyl-2- | 2.0 | 0.5 | 31500 | 3.2 |
| resin A5 | acrylate | | | | | | | pyrrolidone | | | | |
| Crystaline | Behenyl | 21 | 65.0 | Styrene | 15.0 | Methacrylonitrile | 20.0 | — | — | 0.5 | 31600 | 3.4 |
| resin A6 | acrylate | | | | | | | | | | | |
| Crystalline | Behenyl | 21 | 65.0 | Styrene | 15.0 | Acrylonitrile | 10.0 | N-vinyl-2- | 10.0 | 0.5 | 31000 | 3.1 |
| resin A7 | acrylate | | | | | | | pyrrolidone | | | | |
| Crystalline | Behenyl | 21 | 75.0 | Styrene | 5.0 | Methacrylonitrile | 10.0 | N-vinyl-2- | 10.0 | 0.5 | 33500 | 3.3 |
| resin A8 | acrylate | | | | | | | pyrrolidone | | | | |
| Crystaline | Behenyl | 21 | 60.0 | Styrene | 20.0 | Methacrylonitrile | 10.0 | N-vinyl-2- | 10.0 | 0.5 | 32500 | 3.3 |
| resin A9 | acrylate | | | | | | | pyrrolidone | | | | |
| Crystalline | Stearyl | 17 | 15.0 | Styrene | 25.0 | Methacrylonitrile | 10.0 | N-vinyl-2- | 10.0 | 0.5 | 31900 | 3.1 |
| resin A10 | acrylate | | | | | | | pyrrolidone | | | | |
| | Behenyl | 21 | 50.0 | | | | | | | | | |
| | acrylale | | | | | | | | | | | |
| Crystalline | Behenyl | 21 | 61.5 | Styrene | 28.2 | Acrylonitrile | 10.3 | — | — | 0.5 | 31700 | 3.4 |
| resin A11 | acrylate | | | | | | | | | | | |
| Crystalline | Behenyl | 21 | 97.0 | Methacrylic | 3.0 | — | — | — | — | 0.5 | 30800 | 3.5 |
| resin A12 | acrylate | | | acid | | | | | | | | |

Polymerization initiator: 1-butyl peroxypivalate (Perbutyl PV, manufactured by NOF Corp.)

### Preparation of Amorphous Resin B1

A total of 50.0 parts of xylene was charged into an autoclave, the atmosphere was replaced with nitrogen, and the temperature was thereafter raised to 185° C. in a sealed state while stirring. A mixture of 80.7 parts of styrene, 17.8 parts of n-butyl acrylate, 1.1 parts of divinylbenzene, 0.5 parts of acrylic acid, 1.5 parts of di-tert-butyl peroxide, and 20.0 parts of xylene was continuously added dropwise to the autoclave for 3 h while controlling the temperature inside the autoclave at 185° C., and polymerization was carried out. The temperature was kept at the same level for another hour to complete the polymerization, and the solvent was removed to obtain amorphous resin B1. The weight-average molecular weight (Mw) of amorphous resin B1 was 40,000.

### Example 1

### Production of Toner by Suspension Polymerization Method

### Production of Toner Particle 1

| | |
|---|---|
| n-Butyl acrylate | 16.2 parts |
| Styrene | 48.8 parts |
| Colorant: Pigment Blue 15:3 | 6.5 parts |

A mixture consisting of the above components was prepared. The mixture was placed in an attritor (manufactured by Nippon Coke Corporation) and dispersed for 2 h at 200 rpm using zirconia beads with a diameter of 5 mm to obtain a raw material dispersion liquid.

Meanwhile, 735.0 parts of ion-exchanged water and 16.0 parts of trisodium phosphate (12-hydrate) were added to a vessel equipped with a high-speed stirring device Homomixer (Primix Corporation) and a thermometer, and the temperature was raised to 60° C. while stirring at 12,000 rpm. An aqueous calcium chloride solution prepared by dissolving 9.0 parts of calcium chloride (dihydrate) in 65.0 parts of ion-exchanged water was added thereto, and the mixture was stirred at 12,000 rpm for 30 min while maintaining the temperature at 60° C. Then, 10% hydrochloric acid was added thereto to adjust the pH to 6.0, yielding an aqueous medium in which an inorganic dispersion stabilizer containing hydroxyapatite was dispersed in water.

The raw material dispersion liquid was then transferred to a vessel equipped with a stirrer and thermometer, and the temperature was raised to 60° C. while stirring at 100 rpm.

| | |
|---|---|
| Crystalline resin A1 | 35.0 parts |
| Release agent 1 (DP18) | 9.0 parts |
| DP18 (dipentaerythritol stearate wax, melting | |
| point 79° C., manufactured by | |
| Nisshin OilliO Co., Ltd.) | |

The above materials were added and stirred at 100 rpm for 30 min while maintaining the temperature at 60° C., after which 5.0 parts of t-butyl peroxypivalate (Perbutyl PV, manufactured by NOF Corp.) was added as a polymerization initiator and stirring was performed for another minute. The mixture was then poured into the aqueous medium that was stirred at 12,000 rpm in the high-speed stirring device. Stirring was continued for 20 min at 12,000 rpm in the high-speed stirring device while maintaining the temperature at 60° C. to obtain a granulation liquid.

The granulation liquid was transferred to a reaction vessel equipped with a reflux condenser, a stirrer, a thermometer, and a nitrogen inlet tube, and the temperature was raised to 70° C. while stirring at 150 rpm under a nitrogen atmosphere. A polymerization reaction was carried out at 150 rpm for 12 h while maintaining the temperature at 70° C., and a toner particle dispersion liquid was obtained.

The obtained toner particle dispersion liquid was cooled to 45° C. while stirring at 150 rpm, and then heat-treated for 5 h while maintaining the temperature at 45° C. Thereafter, dilute hydrochloric acid was added, while maintaining the stirring, until the pH reached 1.5 to dissolve the dispersion stabilizer. The solid content was filtered off, thoroughly washed with ion-exchanged water, and then vacuum-dried at 30° C. for 24 h to obtain toner particle 1.

### Preparation of Toner 1

To 98.0 parts of toner particle 1, 2.0 parts of silica fine particles (hydrophobized with hexamethyldisilazane, number-average particle size of primary particles: 10 nm, BET specific surface area: 170 m2/g) was added as an external additive. This was mixed for 15 min at 3000 rpm using a Henschel mixer (manufactured by Nippon Coke Corporation) to obtain toner 1.

Table 3 shows the physical properties of the obtained toner 1, and Table 4 shows the evaluation results.

TABLE 2

| | | | Binder resin | | | | |
|---|---|---|---|---|---|---|---|
| | | | | | Amorphous resin B | | |
| | | | Crystalline resin A | | Polymerizable monomer 1 | | |
| | | | | Amount | | Number | Amount |
| Example | Toner | Production | | added | | of carbon | added |
| No. | No. | method | Type | (parts) | Type | atoms m | (parts) |
| 1 | 1 | SP | Crystalline resin A1 | 35.0 | n-butyl acrylate | 3 | 16.2 |
| 2 | 2 | SP | Crystalline resin A1 | 35.0 | n-butyl acrylate | 3 | 19.5 |
| 3 | 3 | SP | Crystalline resin A1 | 35.0 | n-butyl acrylate | 3 | 13.0 |
| 4 | 4 | SP | Crystalline resin A1 | 35.0 | lauryl acrylate | 11 | 16.2 |
| 5 | 5 | SP | Crystalline resin A2 | 35.0 | n-butyl acrylate | 3 | 16.2 |
| 6 | 6 | SP | Crystalline resin A1 | 35.0 | n-butyl acrylate | 3 | 16.2 |
| 7 | 7 | SP | Crystalline resin A1 | 40.0 | n-butyl acrylate | 3 | 15.0 |
| 8 | 8 | SP | Crystalline resin A1 | 45.0 | n-butyl acrylate | 3 | 13.7 |
| 9 | 9 | SP | Crystalline resin A1 | 30.0 | n-butyl acrylate | 3 | 17.5 |
| 10 | 10 | SP | Crystalline resin A3 | 35.0 | n-butyl acrylate | 3 | 16.2 |
| 11 | 11 | SP | Crystalline resin A4 | 35.0 | n-butyl acrylate | 3 | 16.2 |
| 12 | 12 | SP | Crystalline resin A5 | 35.0 | n-butyl acrylate | 3 | 16.2 |
| 13 | 13 | SP | Crystalline resin A6 | 35.0 | n-butyl acrylate | 3 | 16.2 |
| 14 | 14 | SP | Crystalline resin A7 | 35.0 | n-butyl acrylate | 3 | 16.2 |
| 15 | 15 | SP | Crystalline resin A8 | 35.0 | n-butyl acrylate | 3 | 16.2 |
| 16 | 16 | SP | Crystalline resin A9 | 35.0 | n-butyl acrylate | 3 | 16.2 |
| 17 | 17 | SP | Crystalline resin A1 | 35.0 | n-butyl acrylate | 3 | 16.2 |
| 18 | 18 | SP | Crystalline resin A1 | 35.0 | n-butyl acrylate | 3 | 16.2 |
| 19 | 19 | SP | Crystalline resin A1 | 35.0 | n-butyl acrylate | 3 | 16.2 |
| 20 | 20 | SP | Crystalline resin A10 | 35.0 | n-butyl acrylate | 3 | 16.2 |
| Comparative 1 | Comparative 1 | SP | Crystalline resin A1 | 35.0 | lauryl acrylate | 11 | 18.2 |
| Comparative 2 | Comparative 2 | SP | Crystalline resin A1 | 35.0 | lauryl acrylate | 11 | 19.5 |
| Comparative 3 | Comparative 3 | SP | Crystalline resin A1 | 35.0 | — | — | — |
| Comparative 5 | Comparative 5 | SP | Crystalline resin A12 | 35.0 | n-butyl acrylate | 3 | 16.2 |

| | Binder resin | | | | |
|---|---|---|---|---|---|
| | Amorphous resin B | | Polymerization | | |
| | Polymerizable monomer 2 | | initiator | Release agent | |
| | | Amount | Amount | | Amount |
| Example | | added | added | | added |
| No. | Type | (parts) | (parts) | Type | (parts) |
| 1 | St | 48.8 | 5.0 | Dipentaerythritol stearate wax | 9.0 |
| 2 | St | 45.5 | 5.0 | Dipentaerythritol stearate wax | 9.0 |
| 3 | St | 52.0 | 5.0 | Dipentaerythritol stearate wax | 9.0 |
| 4 | St | 48.8 | 5.0 | Dipentaerythritol stearate wax | 9.0 |
| 5 | St | 48.8 | 5.0 | Dipentaerythritol stearate wax | 9.0 |
| 6 | St | 48.8 | 3.0 | Dipentaerythritol stearate wax | 9.0 |
| 7 | St | 45.0 | 5.0 | Dipentaerythritol stearate wax | 9.0 |
| 8 | St | 41.3 | 5.0 | Dipentaerythritol stearate wax | 9.0 |
| 9 | St | 52.5 | 5.0 | Dipentaerythritol stearate wax | 9.0 |
| 10 | St | 48.8 | 5.0 | Dipentaerythritol stearate wax | 9.0 |
| 11 | St | 48.8 | 5.0 | Dipentaerythritol stearate wax | 9.0 |
| 12 | St | 48.8 | 5.0 | Dipentaerythritol stearate wax | 9.0 |
| 13 | St | 48.8 | 5.0 | Dipentaerythritol stearate wax | 9.0 |
| 14 | St | 48.8 | 5.0 | Dipentaerythritol stearate wax | 9.0 |
| 15 | St | 48.8 | 5.0 | Dipentaerythritol stearate wax | 9.0 |
| 16 | St | 48.8 | 5.0 | Dipentaerythritol stearate wax | 9.0 |
| 17 | St | 48.8 | 5.0 | Tripentaerythritol stearate wax | 9.0 |
| 18 | St | 48.8 | 5.0 | Behenyl behenate | 9.0 |
| 19 | St | 48.8 | 5.0 | Paraffin wax (HNP51) | 9.0 |
| 20 | St | 48.8 | 5.0 | Dipentaerythritol stearate wax | 9.0 |
| Comparative 1 | St | 46.8 | 5.0 | Dipentaerythritol stearate wax | 9.0 |
| Comparative 2 | St | 45.5 | 5.0 | Dipentaerythritol stearate wax | 9.0 |
| Comparative 3 | St | 65.0 | 5.0 | Dipentaerythritol stearate wax | 9.0 |
| Comparative 5 | St | 48.8 | 5.0 | Paraffin wax (HNP51) | 9.0 |

Regarding the production method, SP indicates the suspension polymerization method. Further, St indicates styrene. The number m of carbon atoms indicates m in formula (2).

Polymerization initiator: t-butyl peroxypivalate (Perbutyl PV, manufactured by NOF Corp.)

The tripentaerythritol stearate wax used is TP18 manufactured by Nisshin OilliO Co., Ltd. HNP51 is a paraffin wax manufactured by Nippon Seiro Co., Ltd.

TABLE 3

| | | | | | | | | | | | | Regarding (i) of |
|---|---|---|---|---|---|---|---|---|---|---|---|---|
| | | | | | | | Number- | | | | | physical property (1) |
| | | | | | | | average | | | | | Proportion of toner |
| | | | | | | | major | | | | | particles in which no |
| | | | | | | | axis of | Physical | Physical, | Physical | Physical | more than four |
| Example | | D4 | Toner | Toner | | | domain D | property | property | property | property | domains C are |
| No. | Toner | μm | Mw | Mw/Mn | Domain | Matrix | (nm) | (1) | (2) | (3) | (4) | present |
| 1 | 1 | 6.5 | 102500 | 8.9 | Amorphous | Crystalline | 78 | 98 | 93 | 96 | Present | — |
| 2 | 2 | 6.8 | 103800 | 8.8 | Amorphous | Crystalline | 52 | 93 | 91 | 91 | Present | — |
| 3 | 3 | 6.6 | 98900 | 8.7 | Amorphous | Crystalline | 122 | 98 | 92 | 97 | Present | — |
| 4 | 4 | 6.8 | 89800 | 8.8 | Amorphous | Crystalline | 32 | 91 | 86 | 88 | Present | — |
| 5 | 5 | 6.5 | 98900 | 9.4 | Amorphous | Crystalline | 78 | 99 | 97 | 96 | Present | — |
| 6 | 6 | 6.4 | 123200 | 10.7 | Amorphous | Crystalline | 78 | 99 | 97 | 97 | Present | — |
| 7 | 7 | 6.5 | 103800 | 8.7 | Amorphous | Crystalline | 55 | 93 | 91 | 91 | Present | — |
| 8 | 8 | 6.8 | 99900 | 8.6 | Amorphous | Crystalline | 32 | 91 | 88 | 87 | Present | — |
| 9 | 9 | 6.7 | 83590 | 8.1 | Amorphous | Crystalline | 98 | 98 | 96 | 95 | Present | — |
| 10 | 10 | 6.7 | 82640 | 8.1 | Amorphous | Crystalline | 74 | 97 | 93 | 95 | Present | — |
| 11 | 11 | 6.5 | 96700 | 8.4 | Amorphous | Crystalline | 72 | 97 | 93 | 94 | Present | — |
| 12 | 12 | 6.7 | 110080 | 8.7 | Amorphous | Crystalline | 70 | 96 | 94 | 93 | Present | — |
| 13 | 13 | 6.8 | 94800 | 8.3 | Amorphous | Crystalline | 68 | 96 | 93 | 94 | Present | — |
| 14 | 14 | 6.5 | 101050 | 8.5 | Amorphous | Crystalline | 78 | 98 | 93 | 96 | Present | — |
| 15 | 15 | 6.5 | 93800 | 8.2 | Amorphous | Crystalline | 54 | 95 | 91 | 92 | Present | — |
| 16 | 16 | 6.6 | 99800 | 8.2 | Amorphous | Crystalline | 105 | 98 | 93 | 97 | Present | — |
| 17 | 17 | 6.9 | 110050 | 8.4 | Amorphous | Crystalline | 76 | 98 | 93 | 96 | Present | — |
| 18 | 18 | 6.4 | 101800 | 8.4 | Amorphous | Crystalline | 52 | 93 | 91 | 91 | Present | — |
| 19 | 19 | 6.7 | 81800 | 8.1 | Amorphous | Crystalline | 52 | 92 | 88 | 89 | Present | — |
| 20 | 20 | 7.1 | 100800 | 8.1 | Amorphous | Crystalline | 98 | 98 | 94 | 95 | Present | — |
| Compar- | Compar- | 6.8 | 106800 | 8.8 | Amorphous | Crystalline | 29 | 91 | 85 | 86 | Present | — |
| ative 1 | ative 1 | | | | | | | | | | | |
| Compar- | Compar- | 6.8 | 121050 | 8.7 | Amorphous | Crystalline | 27 | 88 | 84 | 84 | Present | 12% |
| ative 2 | ative 2 | | | | | | | | | | | |
| Compar- | Compar- | 6.7 | 110400 | 8.6 | Amorphous | Crystalline | 156 | 96 | 88 | 96 | Present | — |
| ative 3 | ative 3 | | | | | | | | | | | |
| Compar- | Compar- | 7.0 | 101800 | 8.4 | Amorphous | Crystalline | 196 | 35 | 3 | 1 | Present | 65% |
| ative 4 | ative 4 | | | | | | | | | | | |
| Compar- | Compar- | 6.7 | 48900 | 4.3 | Amorphous | Crystalline | None | 0 | 5 | 4 | — | — |
| ative 5 | ative 5 | | | | | | | | | | | |

In the table, D4 indicates the weight-average particle size of the toner.

Physical properties (1) to (4) are as follows.
Physical property (1): proportion (% by number) of cross-sections that satisfy both (i) and (ii) below:
(i) from 5 to 20 domains C are present per cross-section of one toner particle, and the area ratio of domains C is from 10% by area to 30% by area based on the area of the cross-section; and
(ii) domains D are observed over an entire region of a region except for the domain C in the cross-section.
Physical property (2): among the cross-sections, the proportion (%) of cross-sections in which the area ratio of the domains C is from 15% by area to 25% by area based on the area of the cross-section.
Physical property (3): among domains C, the proportion (%) of the cross-sections where the number of domains E having a major axis of 400 nm or more that are present per one particle is from 4 to 20.
Physical property (4): whether the number of the domains D present in any selected 1 μm square region except for the domains C is 100 or more.

In Examples 1 to 20 and Comparative Examples 1 to 4, regarding physical property (1) (ii), domains D were observed over the entire region.

### Examples 2 to 20

Toner particles 2 to 20 were obtained in the same manner as in Example 1, except that the type and amount of polymerizable monomers used, the amount of polymerization initiator added, and the type and amount of release agent added were changed as shown in Table 2.

Furthermore, external addition was performed in the same manner as in Example 1 to obtain toners 2 to 20. Table 3 shows the physical properties of the toners, and Table 4 shows the evaluation results.

### Comparative Examples 1 to 3 and 5

Comparative toner particles 1 to 3 and 5 were obtained in the same manner as in Example 1, except that the type and amount of polymerizable monomer used, the amount of polymerization initiator added, and the type and amount of release agent added were changed as shown in Table 2.

Furthermore, external addition was made in the same manner as in Example 1, and comparative toners 1 to 3 and 5 were obtained. Table 3 shows the physical properties of the toners, and Table 4 shows the evaluation results.

In addition, in Comparative Example 5, domains with a major axis exceeding 250 nm were observed over the entire region.

### Comparative Example 4

### Production of Toner by Pulverization Method

| | |
|---|---|
| Crystalline resin A11: | 50.0 parts |
| Amorphous resin B1: | 50.0 parts |
| Fischer-Tropsch wax; melting point 90° C. | 5.0 parts |
| Colorant; Pigment Blue 15:3 | 9.0 parts |

The above materials were mixed using a Henschel mixer (FM-75, manufactured by Nippon Coke & Engineering Co., Ltd.) at a rotation speed of 20 s⁻¹ and a rotation time of 5 min, and then kneaded in a twin-screw kneader (PCM-30, manufactured by Ikegai Co., Ltd.) set at a temperature of 130° C. with a screw rotation speed of 250 rpm and a discharge temperature of 130° C. The resulting kneaded material was rolled while being cooled using a drum flaker (MBD30-30, manufactured by Nippon Coke Corporation). The temperature of the cooling water was set to 15° C., and the conditions were set so that the thickness of the resin composition after rolling and cooling was 1.0 mm.

The obtained resin composition was coarsely pulverized to 1 mm or less using a hammer mill to obtain a coarsely pulverized product. The resulting coarsely pulverized product was then finely pulverized using a mechanical pulverizer (T-250, manufactured by Freund-Turbo Corp.). Comparative toner particle 4 was obtained by further classifying using Faculty F-300 (manufactured by Hosokawa Micron Corp.). The operating conditions were a classification rotor rotation speed of 130 s⁻¹ and a dispersion rotor rotation speed of 120 s⁻¹.

Furthermore, external addition was carried out in the same manner as in Example 1 to obtain comparative toner 4. Table 3 shows the physical properties of the toners, and Table 4 shows the evaluation results.

### Toner Evaluation Methods

### <1> Low-Temperature Fixability

Process cartridges filled with toners 1 to 20 and comparative toners 1 to 5 were allowed to stand at a temperature of 25° C. and a humidity of 40% RH for 48 h. LBP-712Ci (Canon Inc.) modified to operate even when the fixing unit was removed was used to output an unfixed image with an image pattern in which nine 10 mm×10 mm square images were evenly arranged on the entire transfer paper. The toner laid-on level on the transfer paper was set to 0.80 mg/cm², and the fixing start temperature was evaluated. The transfer paper used was A4 paper (“Prover Bond Paper”: 105 g/m², manufactured by Fox River Co.).

The fixing unit of LBP-712Ci was removed to the outside, and an external fixing unit configured to operate outside the laser beam printer was used. The fixing temperature in the external fixing unit could be raised from 90° C. in 5° C. increments, and fixing was performed at a process speed of 240 mm/sec.

The fixed image was visually checked, the lowest temperature at which cold offset did not occur was defined as the fixing start temperature, and the low-temperature fixability was evaluated according to the following criteria. The evaluation results are shown in Table 4.

### Evaluation Criteria

A: Fixing start temperature is 100° C. or lower
B: Fixing start temperature is from 105° C. to 110° C.
C: Fixing start temperature is from 115° C. to 120° C.
D: Fixing start temperature exceeds 120° C.

### <2> Eraser Abrasion Resistance of Fixed Image

The abrasion resistance was evaluated using the fixed image at the fixing start temperature obtained by the above-described evaluation of low-temperature fixability. The image region of the obtained fixed image was rubbed back and forth 15 times with an eraser (PLAST-0120, manufactured by Reufer Co., Ltd.) with a load of 400 g/cm², and the image density reduction ratio caused by rubbing was calculated. The image density was measured before and after rubbing, and the image density reduction ratio ΔD (%) was calculated using the following formula. This ΔD (%) was used as an index of abrasion resistance.

$$Δ D ( \% ) = \{ ( image density before rubbing ) - ( image density after rubbing ) / ( image density before rubbing ) \} \times 100$$

The image density was measured using a color reflection densitometer X-Rite 404A: manufactured by X-Rite. The evaluation results are shown in Table 4.

### Evaluation Criteria

A: Density reduction ratio is less than 3.0%
B: Density reduction ratio is 3.0% or more and less than 5.0%
C: Density reduction ratio is 5.0% or more and less than 10.0%
D: Density reduction ratio is 10.0% or more

### <3> Evaluation of Gloss

The images fixed at the fixing start temperature and at a temperature 40° C. higher than the fixing start temperature in the above-described <1> Evaluation of low-temperature fixability were used. The gloss value was measured using a handy gloss meter PG-1 (manufactured by Nippon Denshoku Industries Co., Ltd.). The measurement conditions were set to 75° for both the projection angle and the reception angle, and all image patterns arranged at 9 points were measured and the average value was evaluated. Table 4 shows the evaluation results.

### Gloss Evaluation Criteria

A: Average gloss value is 25.0 or more
B: Average gloss value is 20.0 or more and less than 25.0
C: Average gloss value is 15.0 or more and less than 20.0
D: Average gloss value is less than 15.0

TABLE 4

| | | | | Rubbing abrasion | | | | | |
|---|---|---|---|---|---|---|---|---|---|
| | | | | resistance | | | | | |
| | | Low-temperature fixability | | Rubbing | | | | | |
| | | Cold offset | | density | | Gloss fixing start | | Gloss fixing start | |
| | | Fixing start | | reduction | | temperature | | temperature +40° C. | |
| | | temperature | Evaluation | ratio | Evaluation | | Evaluation | | Evaluation |
| | Toner | (° C.) | rank | (%) | rank | Gloss | rank | Glass | rank |
| Example 1 | Toner 1 | 95 | A | 2.0 | A | 27.8 | A | 27.2 | A |
| Example 2 | Toner 2 | 100 | A | 4.8 | B | 26.9 | A | 22.2 | B |
| Example 3 | Toner 3 | 100 | A | 2.5 | A | 15.6 | C | 25.2 | A |
| Example 4 | Toner 4 | 100 | A | 8.8 | C | 25.3 | A | 17.2 | C |
| Example 5 | Toner 5 | 100 | A | 2.1 | A | 27.2 | A | 27.1 | A |
| Example 6 | Toner 6 | 100 | A | 2.0 | A | 26.3 | A | 26.9 | A |
| Example 7 | Toner 7 | 95 | A | 4.3 | B | 26.9 | A | 22.8 | B |
| Example 8 | Toner 8 | 90 | A | 9.2 | C | 25.2 | A | 17.8 | C |
| Example 9 | Toner 9 | 105 | B | 2.2 | A | 23.8 | B | 25.9 | A |
| Example 10 | Toner 10 | 100 | A | 2.3 | A | 27.2 | A | 26.8 | A |
| Example 11 | Toner 11 | 100 | A | 2.9 | A | 27.3 | A | 27.2 | A |
| Example 12 | Toner 12 | 100 | A | 3.2 | B | 27.0 | A | 27.2 | A |
| Example 13 | Toner 13 | 100 | A | 4.9 | B | 26.8 | A | 26.6 | A |
| Example 14 | Toner 14 | 95 | A | 2.1 | A | 27.6 | A | 27.3 | A |
| Example 15 | Toner 15 | 90 | A | 3.9 | B | 27.2 | A | 27.4 | A |
| Example 16 | Toner 16 | 105 | B | 2.0 | A | 20.3 | B | 26.7 | A |
| Example 17 | Toner 17 | 100 | A | 2.0 | A | 27.8 | A | 27.1 | A |
| Example 18 | Toner 18 | 100 | A | 3.9 | B | 26.3 | A | 22.2 | B |
| Example 19 | Toner 19 | 100 | A | 7.2 | C | 26.5 | A | 17.8 | C |
| Example 20 | Toner 20 | 100 | A | 2.0 | A | 23.9 | B | 25.9 | A |
| Comparative | Comparative | 100 | A | 9.2 | C | 25.2 | A | 14.2 | D |
| Example 1 | Toner 1 | | | | | | | | |
| Comparative | Comparative | 100 | A | 11.5 | D | 25.1 | A | 13.2 | D |
| Example 2 | Toner 2 | | | | | | | | |
| Comparative | Comparative | 100 | A | 2.8 | A | 13.8 | D | 25.1 | A |
| Example 3 | Toner 3 | | | | | | | | |
| Comparative | Comparative | 100 | A | 10.9 | D | 13.8 | D | 22.2 | B |
| Example 4 | Toner 4 | | | | | | | | |
| Comparative | Comparative | 100 | A | 13.2 | D | 14.2 | D | 21.7 | B |
| Example 5 | Toner 5 | | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-175142, filed Oct. 10, 2023, which is hereby incorporated by reference herein in its entirety.

What is claimed is:

1. A toner comprising a toner particle comprising a crystalline resin A and an amorphous resin B, wherein
a weight-average particle size of the toner is 4.0 to 10.0 μm;
when a cross-section of the toner is observed with a scanning transmission electron microscope,
a domain-matrix structure in which a domain is dispersed in a matrix is observed in the cross-section,
the matrix comprises the crystalline resin A,
the domain comprises the amorphous resin B,
(a) where the domain with a major axis of 300 nm or more is defined as domain C, and the domain with a major axis of 200 nm or less is defined as domain D, a number-average major axis of the domain D is 30 to 150 nm, and
(b) a proportion of the cross-section which satisfies both of the following (i) and (ii) is 90% or more by number,
(i) 5 to 20 of domains C are present per cross-section of one toner particle, and an area ratio of the domain C is 10 to 30% by area based on an area of the cross-section,
(ii) the domain D is observed over an entire region of a region except for the domain C in the cross-section.

2. The toner according to claim 1, wherein among the cross-section, a proportion of the cross-section in which the area ratio of the domain C is 15 to 25% by area based on the area of the cross-section is 90% or more by number.

3. The toner according to claim 1, wherein, when a domain among the domain C with a major axis of 400 nm or more is defined as domain E,
a proportion of the cross-section where 4 to 20 of domains E are present per one toner particle is 90% or more by number.

4. The toner according to claim 1, wherein the number-average major axis of the domain D is 50 to 100 nm.

5. The toner according to claim 1, wherein a number of the domain D present in any 1 μm square region except for the domains C is 100 or more.

6. The toner according to claim 1, wherein the crystalline resin A has a monomer unit represented by formula (1): 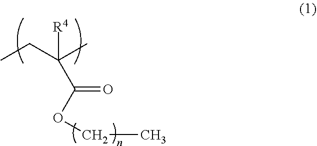
in formula (1), R⁴ represents a hydrogen atom or a methyl group, and n represents an integer of 15 to 35.

7. The toner according to claim 1, wherein the crystalline resin A comprises a monomer unit having a lactam structure.

8. The toner according to claim 7, wherein the lactam structure is a 5-membered lactam structure.

9. The toner according to claim 1, wherein
the toner comprises a release agent,
the release agent comprises a polyfunctional ester wax,
the polyfunctional ester wax is at least one ester compound selected from the group consisting of ester compounds of tetrahydric to octahydric alcohols and aliphatic monocarboxylic acids, and ester compounds of tetravalent to octavalent carboxylic acids and aliphatic monohydric alcohols.

10. The toner according to claim 9, wherein the polyfunctional ester wax is at least one ester compound selected from the group consisting of ester compounds of hexahydric to octahydric alcohols and aliphatic monocarboxylic acids, and ester compounds of hexavalent to octavalent carboxylic acids and aliphatic monohydric alcohols.

11. The toner according to claim 1, wherein the amorphous resin B has a monomer unit represented by formula (2): 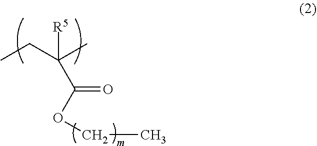
in formula (2), R⁵ represents a hydrogen atom or a methyl group, and m represents an integer of 3 to 35.
